(19) United States
(12) Patent Application Publication
(10) Pub. No.: US 2008/0119144 A1
(43) Pub. Date: May 22, 2008

(54) Label with integrated controller

(76) Inventor: Jason Entner, Brooklyn, NY (US)

Correspondence Address: COOPER & DUNHAM, LLP, 1185 AVENUE OF THE AMERICAS, NEW YORK, NY, 10036, US

(21) Appl. No.: 11/603,456

(22) Filed: Nov. 21, 2006

(51) Int. Cl. H04B 1/034

(52) U.S. Cl. 455/95

(57) ABSTRACT

This invention provides a label affixed to an article of clothing or a piece of luggage comprising an integrated controller device for remote control of an electronic device.

### BACKGROUND OF THE INVENTION

This invention relates generally to the field of control panels for personal portable electronics. More, particularly, this invention relates to an apparatus that incorporates an integrated control panel into a label to be affixed to an article of clothing or other personal article.

Personal audio players (i.e. MP3 players) and cellular phones are commonplace in today's society. Convenient and portable, these personal electronic devices are often carried on an individual's person or personal effects, i.e., pocket, purse, backpack, etc. However, this often requires the user to remove the device from wherever he or she is carrying the device to input commands into the device.

The present invention is an apparatus which allows a user to input commands into a personal electronic device being carried on his or her body via a controller integrated into an exterior label of an article of clothing or personal effect. Allowing use of an electronic device without requiring the user to directly manipulate the device also confers an anti-theft benefit, wherein the device can be safely carried in a pocket or backpack, yet still be controlled and enjoyed.

### SUMMARY OF THE INVENTION

This invention provides a label, wherein the label comprises an integrated controller for remote control of an electronic device.

The advantages and features of the invention will become apparent to those skilled in the art upon consideration of the following description of the invention. The invention may be best understood by reference to the following description.

### BRIEF DESCRIPTION OF THE FIGURES

FIG. 1: View of exterior of one embodiment of the label controller comprising control buttons 1 corresponding to function buttons on the electronic device and an interface 2 through which the label controller is connected to the electronic device.

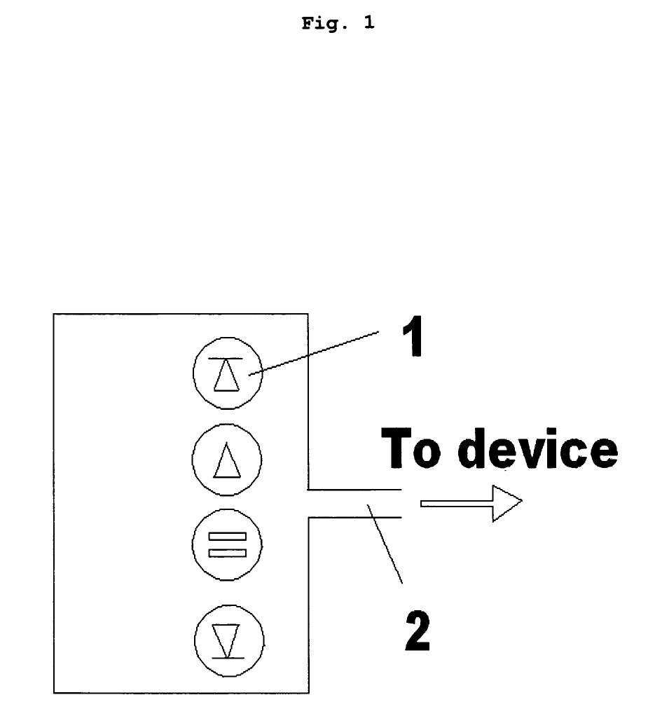

FIG. 2: View of interior of one embodiment of the label controller comprising the sensors for the control buttons corresponding to function buttons on the electronic device 3 and the leads 4 connecting the sensors to the interface for the electronic device.

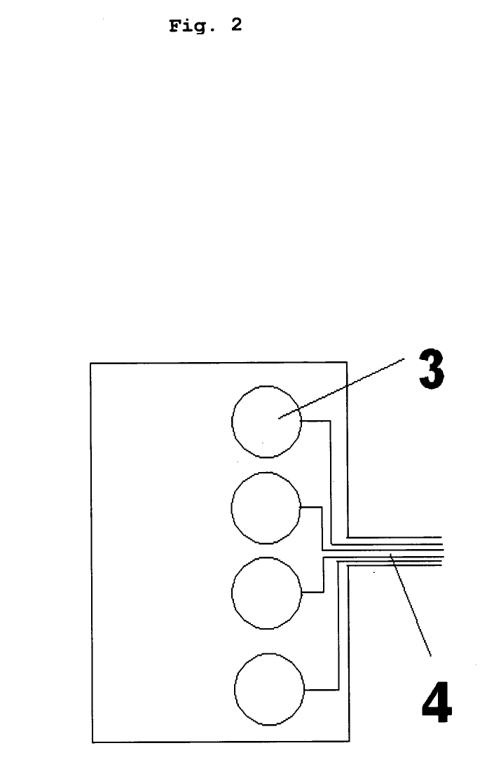

FIG. 3: An embodiment of the claimed label controller integrated into an article of clothing, e.g., a jacket. The figure shows the label controller 5, an embodiment of an interface 6 establishing the connection between the label controller and the electronic device. In this embodiment, the interface is a wire with a suitable connection plug 7 for the electronic device.

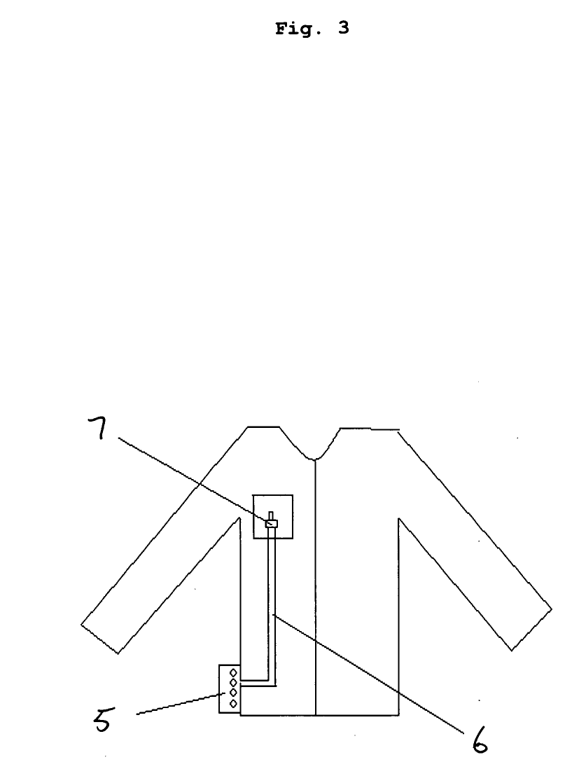

FIG. 4: An embodiment of the claimed invention integrated into a piece of luggage, e.g., a messenger bag. The figure shows the label controller 8, an embodiment of an interface establishing the connection between the label controller and the electronic device 9. The electronic device, shown here as a personal audio player, is carried in an interior pocket of the messenger bag. In this embodiment, the interface is a wire 10 with a suitable connection plug for the electronic device.

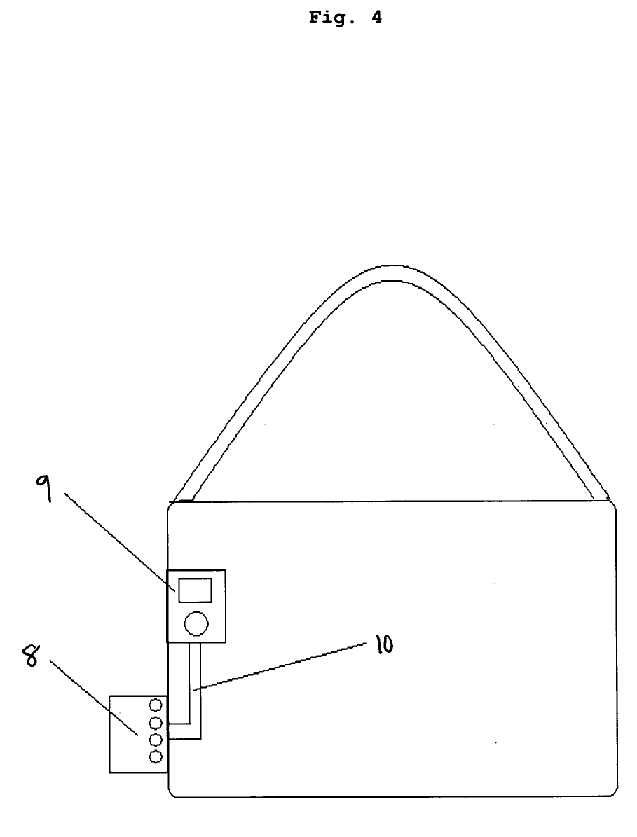

### DETAILED DESCRIPTION OF THE INVENTION

While this invention is susceptible of embodiment in many different forms, specific embodiments will herein be described in detail, with the understanding that the present disclosure is to be considered as an example of the principles of the invention and not intended to limit the invention to the specific embodiments shown and described.

This invention provides a label, wherein the label comprises a controller for an electronic device. The controller connects to the electronic device via suitable interface. The interface can be wireless, e.g., using Bluetooth®, or hardwired, e.g., wires between the label and the device's input output jack or other suitable jack. Information regarding Bluetooth® technology can be found at the “Official Bluetooth® Wireless Info Site.” In the preferred embodiment, the label is affixed to an article of clothing or piece of luggage. In another embodiment, the apparatus that connects the label to the electronic device is integrated into the article of clothing or luggage. In the preferred embodiment, the connecting apparatus is such that it allows the user to carry the electronic device in one location, but allows control of said device via the label at another location.

In one embodiment, the controller is for a personal audio player. In the preferred embodiment, the controller comprises all or some of the functions that appear on the personal audio device, for example, play, rewind, fast forward, skip, pause and volume control. In one embodiment, the controls are accessed via push buttons. In one embodiment, one function is associated with pushing one button. In another embodiment, one function is associated with pushing two or more buttons simultaneously.

In another embodiment, the controller is for a cellular phone. In the preferred embodiment, the controller comprises all or some of the functions that appear on the cellular phone, for example, dial, answer call and end call. In one embodiment, the controls are accessed via push buttons. In one embodiment, one function is associated with pushing one button. In another embodiment, one function is associated with pushing two or more buttons simultaneously.

The claimed invention can be constructed of many materials. In one embodiment, the label is constructed of a flexible material, such as nylon, neoprene, leather or cloth. In one embodiment, the label can be padded and/or insulated to protect the controller from shock, temperature, water, dust or other potentially damaging conditions. In one embodiment, the label is waterproof. In one embodiment, the label is located on the exterior of the article of clothing or of the piece of luggage.

Accordingly, it is intended that the present invention embrace all such alternatives, modifications and variations that fall within the scope of the appended claims.

What is claimed is:

1. A label, wherein the label is affixed to an article of clothing or a piece of luggage, and wherein the label comprises a controller capable of being connected via a suitable interface to an electronic device.

2. The label of claim 1, wherein the interface is wireless.

3. The label of claim 1, wherein the interface is hardwired to the electronic device.

4. The label of claim 1, wherein the interface is integrated into the article of clothing or luggage.

5. The label of claim 1, wherein the controller is for a personal audio player.

6. The label of claim 5, wherein the controller comprises all or some of the functions that appear on the personal audio device.

7. The label of claim 1, wherein the controller is for a cellular phone.

8. The label of claim 7, wherein the controller comprises all or some of the functions that appear on the cellular phone.

9. The label of claim 1, wherein the controls are accessed via push buttons.

10. The label of claim 1, wherein the label is constructed of a flexible material.

11. The label of claim 11, wherein the flexible material is selected from the group consisting of nylon, neoprene, leather or cloth.

12. The label of claim 1, wherein the label is padded and/or insulated.

13. The label of claim 1, wherein the label is waterproof.

14. The label of claim 1, wherein the label is located on the exterior of the article of clothing or of the piece of luggage.
